(19) United States
(12) Patent Application Publication
(10) Pub. No.: US 2010/0297592 A1
(43) Pub. Date: Nov. 25, 2010

(54) SYSTEMS AND METHODS TO INDOCTRINATE AND REWARD A PEER OF A BEHAVIORAL MODIFICATION PROGRAM

(75) Inventors: RICHARD GENGLER, CHICAGO, IL (US); ROGER SWEIS, CHICAGO, IL (US); PETER GENGLER, CHICAGO, IL (US)

Correspondence Address: RICHARD GENGLER, 641 W LAKE ST, SUITE 304, CHICAGO, IL, 60661, US

(73) Assignee: PREVAIL HEALTH SOLUTION LLC, CHICAGO, IL (US)

(21) Appl. No.: 12/471,239

(22) Filed: May 22, 2009

(51) Int. Cl. G09B 19/00; G09B 7/00

(52) U.S. Cl. 434/236; 434/238; 434/350

(57) ABSTRACT

A method of indoctrinating an experienced user of a behavioral modification program run on a microprocessor-based computer as a peer for at least one other user of the behavioral modification program, which selects an experienced user to become the peer, associates the peer with the at least one user within the behavioral modification program, and provides the peer with at least one workflow task. The peer is evaluated and rewarded based upon their performance. The system indoctrinates and rewards a peer for their participation in a behavioral modification program, and consists of a microprocessor configured to execute program instructions residing in memory. The program selects a user to become a peer, associates the peer with a user, provides a workflow task, and evaluates and rewards the peer based on their performance.

### STATEMENT REGARDING FEDERALLY SPONSORED RESEARCH OR DEVELOPMENT

The U.S. Government has a paid-up license in this invention and may have the right in limited circumstances to require the patent owner to license others on reasonable terms as provided for by the terms of Grant No. 0839750 awarded by the National Science Foundation.

### FIELD OF THE INVENTION

The present invention relates to methods and systems for providing behavioral modification, and more particularly to allowing an experienced user of a computerized online behavioral modification program to become a peer to other users, and rewarding the peer for their participation in the program.

### BACKGROUND OF THE INVENTION

Behavior modification is the use of empirically demonstrated behavior change techniques to improve behavior, such as altering an individual's behavior and reaction to stimuli through positive and negative reinforcement of adaptive behavior and/or the reduction of maladaptive behavior through therapy.

Behavior modification is used to treat a variety of problems in both adults and children. Behavior modification has been successfully used to treat obsessive-compulsive disorder (OCD), attention-deficit/hyperactivity disorder (ADHD), phobias, anxiety and depression, among other things.

Besides the personal benefits gained by an individual making and adhering to positive lifestyle changes through behavioral modification, there are societal and economic benefits. For example, behavioral modification patients frequently require fewer physician visits, go to the hospital less often, and have fewer surgeries, reducing long term medical costs.

While various means exist to modify behavior, there are several barriers to implementing modification programs, and ensuring their long-term effectiveness. For instance, personnel and budgetary shortfalls exist in health care systems which could prevent a deserving patient from participating in behavioral modification. Moreover, participation in an ongoing support program is often effective for patients making lifestyle changes, but may involve costly medical staff and facilities.

There may also be stigmas surrounding the receipt of certain types of behavioral modification, such as mental health treatment. A recent Pentagon report estimates that one-third of all soldiers returning from deployment suffer from a mental health disorder. However, lack of adequate resources and fear of stigmatization inherent in seeking face-to-face treatment prevent as much as 77% of military personnel from ever getting the needed treatment.

Moreover, lack of patient adherence to a modification program may prevent long-term success. A few factors attributed to this may be lack of ongoing support mechanisms to ensure program compliance and insufficient means for motivating the patient to make recommended changes.

Therefore, the need for innovative systems and methods to address this burgeoning healthcare epidemic is critical to the well being of our society.

Accordingly, it is an object of the present invention to provide resource and cost-effective support to participants of behavioral modification.

A further object of the present invention is to provide personal support to behavioral modification program users in an environment which removes stigmatization.

A further object of the present invention is to provide performance-based compensation to a peer.

These and other objects and advantages of the present invention will become apparent from the subsequent detailed description of the preferred embodiment and the appended claims taken in conjunction with the accompanying drawings.

### SUMMARY OF THE INVENTION

The objects set forth above as well as further and other objects are achieved by the present invention. The solutions and advantages of the present invention are realized by the illustrative embodiments of the present invention described herein below.

The present invention includes systems and methods of indoctrinating and rewarding individuals acting as peers to users of a behavioral modification program, such as the program disclosed in Applicant's copending patent application Ser. No. ______ filed on May 22, 2009, entitled “SYSTEMS AND METHODS FOR PROVIDING A BEHAVIORAL MODIFICATION PROGRAM,” which is fully incorporated herein by reference. In an illustrative embodiment, a method is provided for indoctrinating and rewarding an experienced user of a behavioral modification program run on a microprocessor-based computer as a peer for at least one other user of the behavioral modification program. An experienced user is selected to become a peer and then associated with a user. The selection and association may be carried out through the artificial intelligence of the behavioral modification program. The peer is provided with workflow tasks which must be completed, the tasks providing assistance and support to users of the behavioral modification program. The program then evaluates the peer based on their performance, and rewards them with a rating and/or some form of compensation.

In another illustrative embodiment, a computer-based system is provided to indoctrinate and reward a peer for their participation in a behavioral modification program. The system includes memory containing the behavioral modification program instructions which is coupled to a microprocessor configured to execute the instructions. An experienced user is selected as a peer and associated with a user of the behavioral modification program. The peer is provided with a workflow task, and evaluated and rewarded based on their performance of same.

The system may further include a communications interface coupled to the processor, and a client device having a communications interface, both of which are configured to interface with a network. This would allow the client device to access the behavioral modification program over the internet through a web-enabled browser.

In the illustrative embodiments, the behavioral modification program would be artificially intelligent and able to learn information from users of the program. This would allow the program to operate more efficiently over time by providing capabilities to effectively tailor modification courses and better evaluate and reward the user's activities.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 is a flow diagram illustrative of a method of indoctrinating an experienced user of a behavioral modification program run on a microprocessor-based computer according to an embodiment of the invention;

FIG. 2 is a flow diagram illustrative of a method of evaluating and rewarding a peer based upon their performance within a behavioral modification program run on a microprocessor-based computer according to an embodiment of the invention;

FIG. 3 is a flow diagram illustrative of a method of indoctrinating, evaluating and rewarding a peer based upon their performance within a behavioral modification program run on a microprocessor-based computer according to an embodiment of the invention; and

FIG. 4 is a block diagram of a system to indoctrinate and reward a peer for their participation in a behavioral modification program according to an embodiment of the invention.

### DETAILED DESCRIPTION OF THE PREFERRED EMBODIMENT

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

In a preferred embodiment of the invention, a method is provided for modifying the behavior of the user of a computer-based behavioral modification program. A computer may include any device having software processing capabilities provided by, but not limited to, a microprocessor, commonly referred to as a processor, Intel® Pentium® processor, central processing unit (CPU), graphical processing unit (GPU), or other such processing devices known to one skilled in the art. Multiple computing devices or pieces of hardware may be connected or otherwise in communication locally and/or in a distributed platform, which may individually or collectively be considered as one or more microprocessors or processing units.

It is also preferred that the behavioral modification program be distributed through an online platform, whereby a host or server computer contains and/or executes the behavioral modification program and serves it to users, most preferably as a web-based program accessed through a web browser. However, it is also contemplated that the behavioral modification program could be run on various computer systems and networks, such as a single local computer; through machines connected on a local intranet which would not require the use of the internet; through cloud computing; or any other configuration allowing a user to access the program, as would be recognized by those skilled in the art.

With respect to this and other embodiments of the systems and methods herein disclosed, a behavioral modification program user may include, but is not limited to, patients, peers, system administrators, and program administrators. Patients may be considered those users who desire to have their behavior modified by the behavioral modification program. A peer may be a patient who has completed a behavioral modification program and now acts in a support capacity to current patients. System administrators may include users which provide technical support relating to the system. Program administrators may be users who provide medical or non-technical advice and assistance to a patient, such as doctors and clinicians. Generally, the term “user” as referenced herein refers to a patient. However, the user and aforementioned types of users are merely provided for exemplary purposes, and are not wholly indicative of the various users who may participate in the disclosed methods and systems.

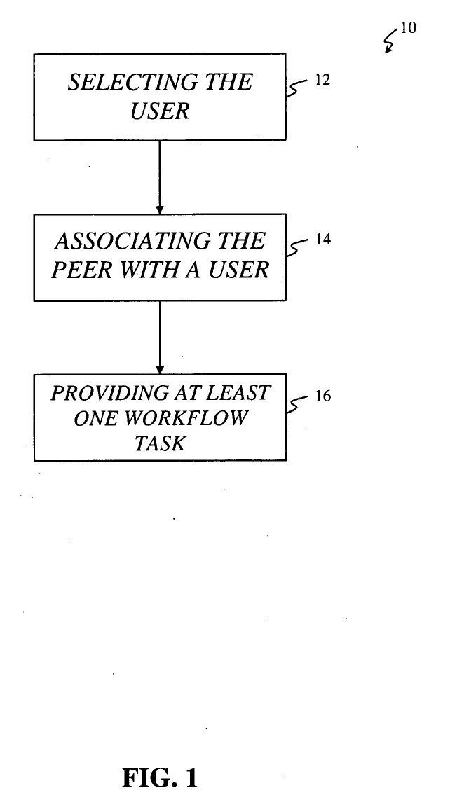

Referring to FIG. 1, a method 10 is disclosed in which an experienced user of the behavioral modification program is selected 12 to become a peer. While it is contemplated that a person with no prior experience with the behavioral modification program may be selected 12 to become a peer and thus be considered an experienced user, it is preferred that a user be selected 12 who is familiar with the program. The user may be experienced in that they have participated in a training program or the like regarding the behavioral modification program, or they have had experience using the program, whether it be as a patient undergoing behavioral modification or simply to familiarize themselves with the program in anticipation of becoming a peer. It is preferred that the experienced user be a person who has completed the entire behavioral modification program or program series. It is also preferred that the selection 12 is made by the behavioral modification program, although in certain embodiments the selection 12 may be made by a user or administrator of the behavioral modification program. The selection 12 may be determined at random, or preferably is based upon some decision metric employed by the behavioral modification program via an algorithm. For example, there may be some initial criteria to be fulfilled before an experienced user may be eligible as a peer candidate, such as completing an entire behavioral modification program.

Once an appropriate experienced user is selected 12 to become a peer, they may be associated 14 with at least one user of the behavioral modification program. It is preferred that at least one association 14 be made when a user begins the behavioral modification program, although subsequent associations 14 made be made at any time during the program. While the association 14 may be determined by the program administrator, system administrator, or the user, it is preferred the behavioral modification program “intelligently” make the association using an algorithm which considers certain criteria, such as the demographics of the parties.

Once a peer has been associated 14 with a user, the peer is provided 16 at least one workflow task. A workflow task is a task the peer must complete so that the peer may eventually be rewarded. In most if not all cases, the workflow task, will be related to a user (either associated or non-associated). Preferably, the workflow task is generated and assigned by the behavioral modification program; however the system or program administrators may also have this ability.

A workflow task may also be created through the acts of, or by request of, a user, administrator, or the program itself. Such a task would be issued as an electronic “ticket” to the peer, the ticket representing a workflow task to be completed. For instance, the ticket could represent a reminder call the peer must make to their associated user. Once the peer accomplishes the task, the ticket would be closed out, preferably by the behavioral modification program.

Workflow tasks may be dependent on the particular behavioral modification program of the user, or may be generic tasks which are program independent. Exemplary program independent tasks of a preferred embodiment include, but are not limited to, chatting with a user, messaging a user, and reminding a user of an upcoming scheduled event. A workflow task that is program dependent may be to plan a menu for a user who is modifying behavior to lose weight.

Workflow tasks which are provided 16 to a peer with specific regard to their associated user(s) are considered “matched” workflow tasks. Said another way, when a peer is completing a workflow task for their associated user, it is a matched workflow task. The peer may also be provided the opportunity to participate in workflow tasks for unassociated users, which are considered “unmatched” workflow tasks. In a preferred embodiment, unmatched tasks may only be initiated by the unassociated user rather than the peer, thus denying the peer the ability and incentive to participate in numerous unmatched tasks solely to increase their number of completed workflow items. Additionally, a peer may not be evaluated on or rewarded for such tasks for the same reason.

During an unmatched workflow task, the user may have the ability to “buddy” themselves with a peer they are interacting with, and thus become associated with the peer from that point forward. Buddying may also occur at other times. Before the association becomes effective, it may be reviewed by a third party, such as a system or program administrator, or by the behavioral modification program itself, to ensure the peer is qualified to be associated with the user.

Also in a preferred embodiment, certain workflow tasks should occur at specific times in the user's behavioral modification program. For example, it is preferred that a matched peer-user chat take place directly before a user participates in a behavioral modification education module, so as to motivate the user to complete the module.

According to an embodiment of the invention, the number of workflow tasks provided to the peer is based on certain criteria, the number and selection of which is preferably carried out by an algorithm of the behavioral modification program. Such criteria may include, but is not limited to, the number of users associated with a peer, the number of workflow tasks already assigned to the peer, average rating ascribed to a peer by associated users, the number of overall peer-user interactions and demographics of the peer and user. Moreover, the number of users assigned to a peer may be decided by the behavioral modification program using a similar algorithm-based decision metric. For example, a peer who is highly rated but does not have many workflows tasks assigned to them may be associated with a user living near by, and assigned several workflow tasks for that user.

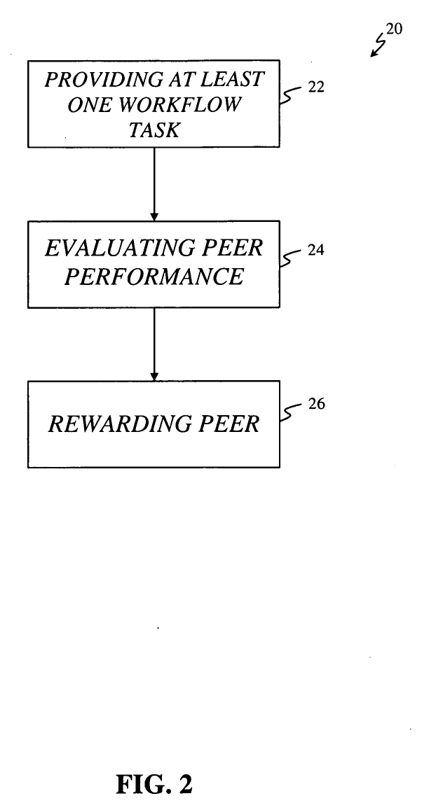

In another embodiment of the invention, according to FIG. 2, a method 20 is disclosed for evaluating and rewarding a peer based upon their performance. As in previously disclosed embodiments, a peer is provided with at least one workflow task 22, preferably by the behavioral modification program.

The method 20 may further include the step of evaluating the peer's performance 24 by the behavioral modification program through use of at least one algorithm, although it is also contemplated that a person, such as an administrator, may provide the evaluation 24.

The evaluation 24 may be based upon one or more factors such as the number and type of workflow tasks completed, as well as how the peer was rated by a user for such tasks. The evaluation 24 may include calculating a peer's rating by averaging all the individual ratings ascribed by the users, determining whether a peer is complying with their tasks, or assessing whether a peer should be given additional users. Moreover, only certain activities may be evaluated 24, such as unmatched workflow tasks.

When factors relating to the quality of a peer's work are taken into account during the evaluation 24, such as the rating ascribed by a user during a chat session, the motivation for a peer to complete several workflow tasks without regard for the quality of their participation is removed. To reinforce this, in certain embodiments workflow tasks must either be assigned to a peer (preferably based on their rating and the like) or initiated by a user, thus removing the peer's ability to independently control the number of workflow tasks they are able to complete. Overall, this methodology should improve the quality of the peer's work, and thus the effectiveness and quality of the behavioral modification program for a user.

The evaluation 24 may be an ongoing background process performed by the behavioral modification program, which is executed and goes unnoticed by the user. Additionally or conversely, the evaluation 24 may be performed at certain times throughout the behavioral modification program. In a present embodiment, proprietary algorithms are employed to make the evaluation 24, the algorithms preferably being artificially intelligent. The artificial intelligence may allow the behavioral modification program to change and be adapted over time to improve the evaluation 24 process, as more information will be learned by the program with each successive user.

Once a peer has been evaluated 24 by the behavioral modification program, they may be rewarded 26 in some manner. The reward may be based, at least in part, on some aspect of the user evaluation 24. For instance, if the evaluation 24 determines the peer has completed forty workflow tasks, and appropriate reward for forty tasks may be given. However, the reward is not required to be based upon the evaluation 24. Furthermore, the peer may only be rewarded for certain things, such as matched workflow tasks.

The reward may give the peer incentive for future participation in the program. Accordingly, the reward may be any form of monetary or non-monetary compensation, such as gift certificates, discounts on products, and currency. If monetary compensation is provided, the peer may be able to use the behavioral modification program as a source of income. Moreover, a peer may be given additional, free, or reduced price access to the behavioral modification program where access is limited or on a paid basis.

The reward may also include ascribing a score, rating or points to the peer, which can serve any number of purposes. If points are awarded, they may be redeemed for something else of value. If a rating is rewarded, a peer may be motivated to obtain a high rating, especially when the rating is viewable by others using the behavioral modification program. This could provide incentive for a user to associate themselves with a highly rated peer, which may in turn further increase the peer's rating by providing the peer with additional workflow tasks to be completed for the new user.

Since it is likely an experienced peer would be associated with several users which each rate the peer, the reward may comprise an ongoing total, average, or other metric of the rating, score, points, or rewards provided throughout the program. Thus, the reward may be positively or negatively affected each time a peer is rated by a user.

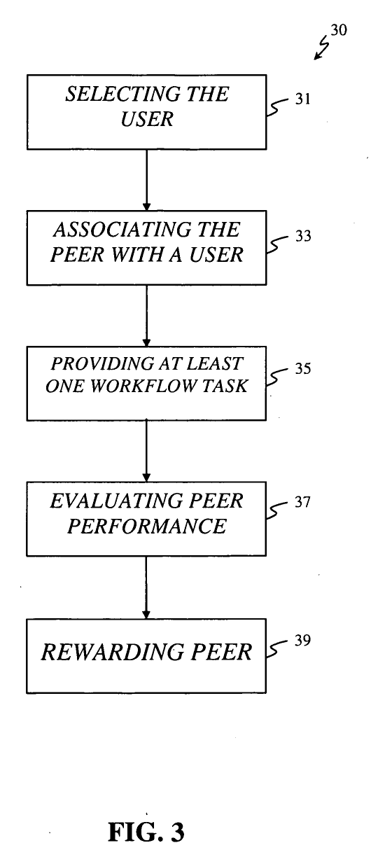

According to another embodiment as referred to in FIG. 3, the steps of previous methods are practiced together, disclosing a method 30 to indoctrinate and reward a peer for their participation in a behavioral modification program. The method 30 includes selecting the experienced user of the behavioral modification program to become a peer 31; associating the peer with the at least one user within the behavioral modification program 33; providing the peer with at least one workflow task within the behavioral modification program 35; evaluating the peer's performance by the behavioral modification program 37; and rewarding the peer 39.

With respect to the methods disclosed herein, the method steps provided are not required to be practiced in any particular order unless there is some dependence or relationship which would require such a practice.

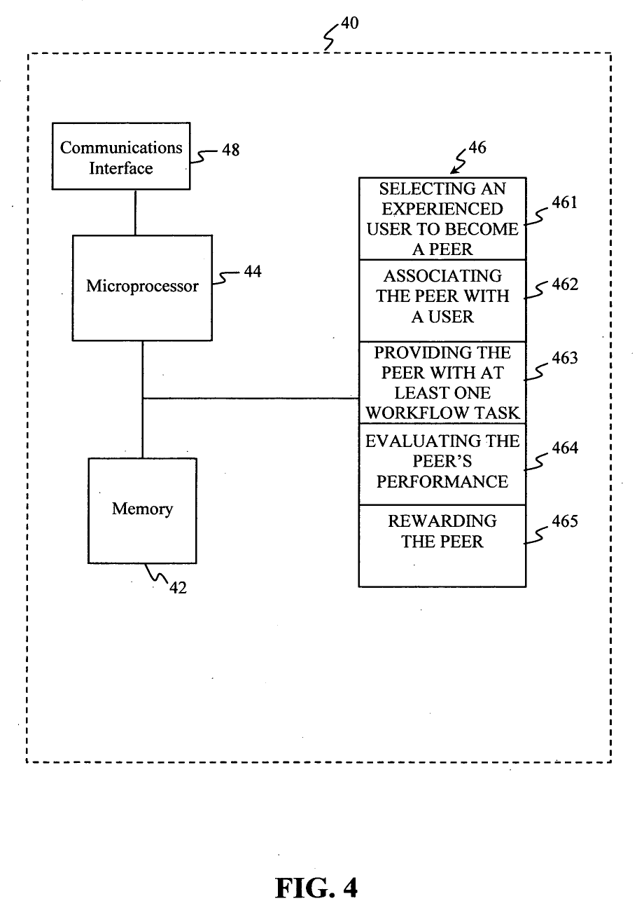

Referring to FIG. 4, a system 40 is disclosed to indoctrinate and reward a peer for their participation in a behavioral modification program. The system 40 includes at least one memory 42 having behavioral modification program instructions residing thereon. Examples of memory 42, which enable the storage, reading, and/or running of a software program therefrom, include RAM, ROM, hard disks, CDs, DVDs, flash memory, and any other form of local and remote, volatile and non-volatile storage media which may be accessed directly and indirectly by a microprocessor.

The system further includes at least one microprocessor 44 configured to execute the behavioral modification program instructions. Such execution may be carried out by direct or indirect access and reading of the software instructions on the at least one memory 42 by the at least one microprocessor 44, or may involve other, additional hardware and software to carry out same.

The program instructions allow the system to perform several operations 46, which may include at least one of the following: selecting an experienced user of the behavioral modification program to become a peer 461; associating the peer with the at least one user 462; providing the peer with at least one workflow task 463; evaluating the peer's performance 464; and rewarding the peer 465.

While it is preferred that a user complete the behavioral modification program in one session, it is provided that the user may participate in the program in multiple sessions.

Additionally, a preferred embodiment of the system 40 further includes a communications interface 48 coupled to the processor 44 and configured to interface with a network, and/or a client device (not shown) having a communications interface configured to interface with a network. This system configuration would allow a client device to access, run, or otherwise allow the user to experience the behavioral modification program over a network.

The user device may be a computer, personal digital assistant (PDA), cellular phone, video game console, web-enabled television, or any device having network connectivity capabilities. In this embodiment, the term network is used generally to mean any environment which allows the program to be remotely accessed by the user, such as through wired/wireless ethernet, the internet, LAN, WAN, VPN and the like, as would be known to one having skill in the art. The communications interface and network may implemented in a number of various way, including but not limited to, wireless and wired interfaces, RS-232, wired and wireless ethernet, telephone modem, cable modem, universal serial bus (USB), firewire, radio, infrared, bluetooth, HSPA, cellular, satellite, GSM, LAN, WAN, EVDO, and any other types of communications interface and networks as would be known to those skilled in the art.

The present invention includes any novel feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

1. A method of indoctrinating an experienced user of a behavioral modification program run on a microprocessor-based computer as a peer for at least one other user of the behavioral modification program, the method comprising:
selecting the experienced user of the behavioral modification program to become the peer,
associating the peer with the at least one user within the behavioral modification program; and
providing the peer with at least one workflow task within the behavioral modification program.

2. The method according to claim 1 wherein the experienced user must have completed the entire behavioral modification program.

3. The method according to claim 1 wherein the association is made by at least one associator selected from the group consisting of program administrator, system administrator, user and computer algorithm.

4. The method according to claim 1 wherein the association occurs when the at least one associated user begins the behavioral modification program.

5. The method according to claim 1 wherein the at least one workflow task is selected from the group consisting of messaging, chatting and closing a ticket.

6. The method according to claim 1 wherein the at least one workflow task is a chatting activity which occurs before the at least one associated user begins a behavioral modification program lesson.

7. The method according to claim 1 wherein the at least one workflow task includes matched and unmatched workflow tasks.

8. The method according to claim 7 wherein the unmatched workflow task must be initiated by the user.

9. The method according to claim 7 wherein a user may associate themselves with a peer during an unmatched workflow task.

10. The method according to claim 1 wherein the number of workflow tasks provided to the peer is based on at least one criteria selected from the group consisting of number of users associated with a peer, number of workflow tasks already assigned to the peer, rating ascribed to a peer by users, number of overall peer-user interactions and demographics.

11. The method according to claim 1 wherein the peer can not dictate the number of workflow tasks provided.

12. The method according to claim 1 wherein the peer is associated with additional users based upon the peer's performance.

13. The method according to claim 1 further comprising evaluating the peer's performance by the behavioral modification program and rewarding the peer.

14. A method of evaluating and rewarding a peer based upon their performance within a behavioral modification program run on a microprocessor-based computer, the method comprising:
providing the peer with at least one workflow task within the behavioral modification program;
evaluating the peer's performance by the behavioral modification program; and rewarding the peer.

15. The method according to claim 14 wherein the evaluation relates to the performance of the at least one workflow task.

16. The method according to claim 14 wherein the evaluation is based upon at least one criteria selected from the group consisting of peer rating by users, number of workflow tasks completed, number of interactions with users, number of associated users, and progress of an associated user through the behavioral modification program.

17. The method according to claim 14 wherein the reward includes at least one item selected from the group consisting of non-monetary compensation, monetary compensation, discount goods, discount services, and further peer participation in the behavioral modification program.

18. A system to indoctrinate and reward a peer for their participation in a behavioral modification program comprising:
at least one memory having behavioral modification program instructions residing thereon; and
at least one microprocessor configured to execute the behavioral modification program instructions to perform the operations of:
selecting an experienced user of the behavioral modification program to become a peer;
associating the peer with the at least one user;
providing the peer with at least one workflow task;
evaluating the peer's performance; and
rewarding the peer.

19. The system according to claim 18 further comprising:
a communications interface coupled to the processor and configured to interface with a network; and
a client device having a communications interface configured to interface with a network, wherein the client device is able to remotely access the behavioral modification program through the network.

20. The system according to claim 19 wherein the client device access to the system is provided through a web browser over the Internet.
